(19) United States
(12) Patent Application Publication
(10) Pub. No.: US 2005/0285302 A1
(43) Pub. Date: Dec. 29, 2005

(54) Mold and process for producing a shoe bottom

(76) Inventors: Daniel M. Doerer, St. Louis, MO (US); Duane Shelton, Bourbon, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/920,812

(22) Filed: Aug. 18, 2004

Related U.S. Application Data
(60) Provisional application No. 60/583,580, filed on Jun. 28, 2004.

(51) Int. Cl. B29C 33/40

(52) U.S. Cl. 264/223; 249/135

(57) ABSTRACT

A mold for producing a shoe bottom has a drag which contains a mold cavity in the configuration of the shoe bottom and a cope which fits against the drag and closes the mold cavity. To form the drag, a model is placed against the cope, and a metallic coating is applied to the exposed surfaces of the model and the surrounding parting surface of the cope. A form is installed around the parting surface of the cope and a fluent backing is introduced into it and allowed to solidify over the metallic coating to form a backing for the metallic surface. After the drag and cope are separated the model is removed from the drag, thus providing the mold cavity in which shoe bottoms are molded.

### CROSS-REFERENCE TO RELATED APPLICATIONS

This application derives priority from U.S. provisional application No. 60/583,580 filed Jun. 28, 2004, for the invention of Daniel M. Doerer, from which priority is claimed.

### STATEMENT REGARDING FEDERALLY SPONSORED RESEARCH

Not applicable.

### BACKGROUND OF THE INVENTION

This invention relates in general to footwear and, more particularly, to a mold, to a process for producing the mold, and to a process for producing shoe bottoms using the mold.

Most shoes of current manufacture have one-piece shoe bottoms, which are in essence on unified soles and heels. The typical shoe bottom is produced in a steel mold by injecting a thermoplastic material into the mold and allowing it to solidify. The manufacture of the molds involves considerable machining of steel or of casting steel, both of which are complex, require a good measure of highly skilled labor, and are time consuming. As a consequence, molds for shoe bottoms are expensive.

The expense is justified—and may indeed be necessary—where a mold produces a large number of shoe bottoms. This occurs generally where a mold produces bottoms for a popular shoe size. But to market a shoe of any particular style, the shoe must be available in multiple sizes, some considerably more popular than others. The strength and durability of steel molds justifies their expense in molds for the more popular shoe sizes, but rarely for the shoes of less popular sizes which are usually the sizes at the ends of the size spectrum. Yet a shoe manufacturer must have all sizes to remain competitive.

### BRIEF DESCRIPTION OF THE SEVERAL VIEWS OF THE DRAWINGS

In the accompanying drawings which form part of the specification:

FIG. 1 is a sectional view of a mold constructed in accordance with and embodying the present invention;

FIG. 2 is a perspective view of the mold with its drag and cope separated;

FIG. 3 shows perspective views of a shoe bottom formed in the mold;

FIG. 4 is a perspective view of the cope with a model of the shoe bottom on it;

FIG. 5 is a perspective view of the cope and model as a metallic coating is applied to them;

FIG. 6 is a perspective view of the cope and model with a form surrounding the model to provide a form cavity that receives a thermosetting polymer; and

FIG. 7 is a perspective view of the drag as the model is removed from it.

### DETAILED DESCRIPTION OF THE INVENTION

Referring now to the drawings, a mold A (FIGS. 1 & 2) is suitable for producing a shoe bottom B (FIG. 3) quickly and efficiently in that it accepts a thermoplastic material which is injected into it under considerable pressure and fills the void of the mold A. As a consequence, the bottom B acquires the configuration of the mold interior, including any surface textures or patterns in the mold interior.

The shoe bottom B (FIG. 3) on its bottom has a sole surface 2 and a heel surface 4, often with an arch surface 6 between the sole and heel surfaces 2 and 4. The sole surface 2 and heel surface 4 have contours and other patterns and textures to enhance traction and aesthetics. The arch surfaces 6 to a lesser measure may have the same. The shoe bottom B also has an upper surface 8, usually with minimum texture or pattern. Finally, the bottom B has a contoured peripheral surface 10, often with texture and distinct patterns. All the contours, patterns and textures for the surfaces 2, 4, 6, 8 and 10 derive from the mold A.

The mold A includes (FIGS. 1 & 2) a drag 20 and a cope 22 which fit together and enclose a mold cavity 24 having the contours and the surface patterns and textures of the shoe bottom B that is formed in the mold A. The drag 20 contains essentially the entire mold cavity 24, but in the absence of the cope 22, the cavity 24 is exposed on the drag 20.

Therefore, the drag 20 is more complex than the cope 24 which is essentially a lid. Indeed, the drag 20 possesses a composite construction, it having a resin backing 28 and a metal coating 30 formed over the backing 28 at least on the surfaces of the mold cavity 24, and preferably beyond. The cope 22 is formed from solid steel. Both the drag 20 and cope 22 have parting surfaces 32 and 34, respectively, which conform precisely and abut around the cavity 24 when the mold A is closed. Thus, the parting surface 32 of the drag 20 surrounds much of the mold cavity 24. The parting surface 34 of the cope 22 surrounds a positioning surface 36 which actually closes the mold cavity 24 formed by the drag 20.

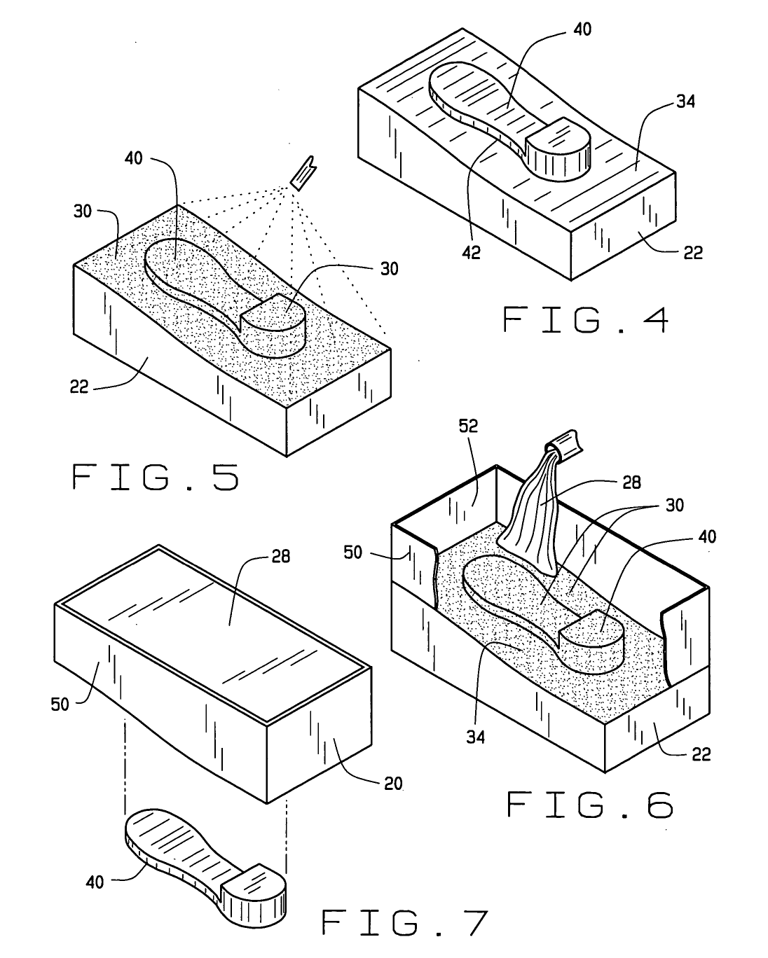

To produce the mold A, one begins by making a model 40 (FIG. 4) that possesses the configuration of the shoe bottom B one desires to mold. It replicates the sole, heel and arch surfaces 2, 4 and 6 desired for the shoe bottom B and the peripheral surface 10 as well. It is formed from a material that is easily shaped. Wood and wax are suitable materials. They permit intricate contours, patterns and textures to be formed in the model 40 for the surfaces 2, 4, 6 and 10 with relatively little effort. The model 40 has a back face 42 which in contour may correspond to the upper surface 8 that is desired for the shoe bottom B. At least along its periphery the back face 42 should correspond in contour to the positioning surface 36 of the cope 22.

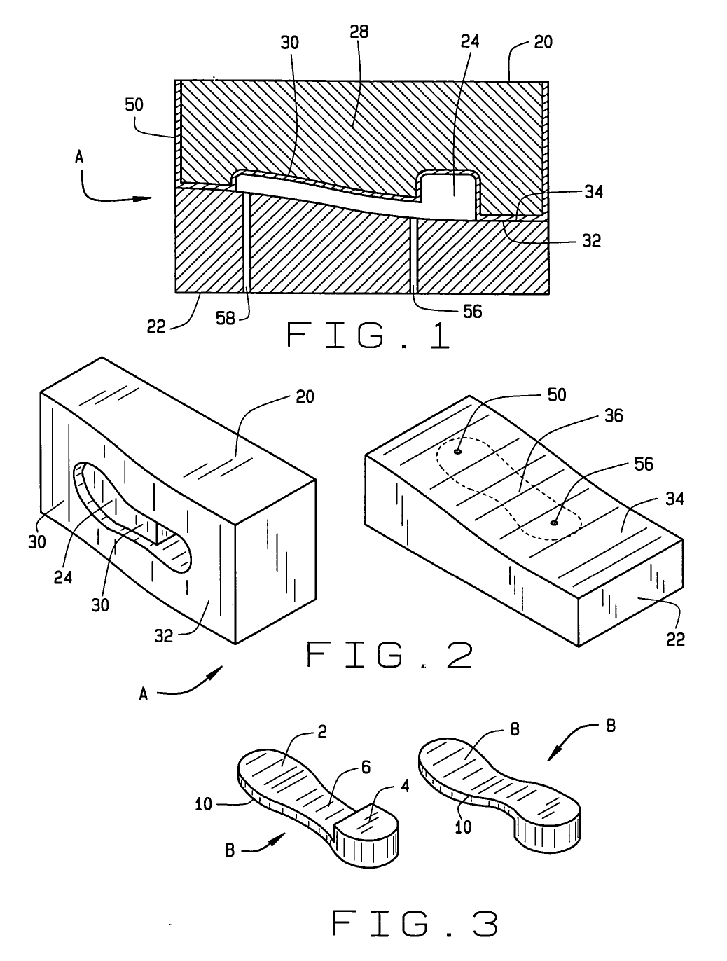

Next one constructs the cope 22 from steel, and in so doing machines its parting surface 34 and the positioning surface 36 that the parting surface 34 surrounds (FIGS. 2 & 4). The surface 36, possesses the contour and texture of the upper surface 8 for the desired shoe bottom B. The rest of the cope 22 is relatively inconsequential, except for the fact that it must support the surfaces 34 and 36 and prevent them from distorting.

At this juncture one places the model 40 over the cope 22, with the back face 42 of the model 40 against the positioning surface 36 of the cope 22 (FIG. 4) and secures the model 40 in that position, for example, with double stick tape that adheres to the surface 36 of the cope 22 and the opposing surface of the model 40 or with countersink screws that pass through the cope 22 and extend into the model 40. This leaves the remaining surfaces of the model 40, including the contours, patterns and textures of those surfaces, exposed.

With the model 40 secured to the cope 22, a thin coating of metal is applied to the exposed surfaces of the model 40 and the surrounding parting surface 34 on the cope 22 (FIG. 5). The coating, which becomes the coating 30 on the drag 20, possesses a thickness ranging between 0.03 and 0.060 inches and may be formed from any of a variety of metals. Aluminum and its alloys, steel, and tin-zinc alloys are all suitable, with the aluminum alloy 356T6 perhaps being preferred The metallic coating 30 may be applied by flame spraying. In this process a wire formed from the metal desired for the coating 30 is fed into a flame hot enough to melt the metal. At the same time the molten metal is subjected to a high velocity stream of air which atomizes the metal and drives it away from the flame. Indeed, the atomized metal is directed against exposed surfaces of the model 40 and likewise against the surrounding parting surface 34 on the cope 22. The atomized metal builds up on the surfaces, until it reaches the desired thickness, at which time the spraying is terminated. The spraying leaves in the coating 30 the contours, patterns and textures possessed by the exposed surfaces of the model 40.

Next the coated model 40 is enclosed in a form 50 that is brought against the cope 22 and around the coated parting surface 34 of the cope 22 (FIG. 6). The form 50 provides the sides of a form cavity 52, while the metal coating 30 that extends over the mold 40 and the parting surface 34 provides the bottom of the form cavity 52. The form 50, like the model 40, is positioned securely with respect to the cope 22. The top of the form 50 remains open so through it the coated model 40 and parting surface 34 are exposed.

With the form 50 in place around the model 40 and positioned securely on the cope 22, a thermosetting polymer in fluent condition is directed into the form cavity 52 (FIG. 6). It adheres to the coating 30 that covers the model 40 and the parting surface 34 at the bottom of the form cavity 52 and also adheres to the form 50 at the sides of the form cavity 52. Indeed it fills the form cavity 52 where it solidifies into the backing 28. The polymer—and the backing 28 into which it solidifies—may be an aluminum-filled epoxy.

At this juncture the form 50 as well as the backing 28 and model 40 within it are removed from the cope 22. In this regard, the metal coating 30 adheres lightly, if at all, to the model 40 and the parting surface 34 of the cope 22, but the thermosetting polymer and the backing 28 into which it solidifies adhere much more tightly to the coating 30. Thus, the coating 30 separates easily from the parting surface 34 of the cope 22 and from the model 40.

Once the form 50 and model 40 are separated from the cope 22, the model 40 is removed from the form 50, that is to say, it is separated from the coating 30 that adheres to the backing 28 (FIG. 7). The form 50 may remain in position as part of the completed mold A to act as a chase for wall support. If the mold cavity 24 possesses sufficient draft, the model 40 can simply be withdrawn intact from it. Otherwise, it may have to be chipped out, if formed from wood, or melted if formed from wax. In any event, the removal of the model 40 leaves the backing 28 and surrounding form 50 with a void, it being the mold cavity 24 which is lined with the metal coating 30. In other words, the form 50, backing 28, and coating 30, with the model 40 removed, becomes the drag 20.

At some time the cope 22 is provided with a sprue 56 and air vents 58 at suitable locations (FIG. 1). This completes the cope 22.

To produce a shoe bottom B from the mold A, the drag 20 and cope 22 are brought together (FIG. 1) with the parting surface 32 on the drag 20 against the parting surface 34 on the cope 22. Indeed, the drag 20 and cope 22 are clamped tightly together. This totally encloses the mold cavity 24, save for the small ports formed by the sprue 56 and air vents 58.

Thereupon, a thermoplastic polymer is injected into the mold cavity 24 through the sprue 56 in the cope 22. It completely fills the mold cavity 24 where it solidifies into the shoe bottom B. Separating the cope 22 and drag 20 leaves the shoe bottom B exposed in the mold cavity 24. Being flexible, the shoe bottom B is easily removed from the mold cavity 24.

The time, effort and cost of constructing the drag 20 for the mold A are considerably less than the time, effort and cost of machining a drag from a block of steel. Moreover, should the drag 20 fail, it is easily replicated, particularly if the model 40 from which it is formed remains intact.

Variations are possible. For example, the cope 22 may be fitted with the form 50 before the model 40 is installed against the positioning surface 36 on the cope 22. Also, the metallic coating 30 may be applied to model 40 in the absence of the cope 22, and the backing formed over the coating 30 in the absence of the cope 22 as well. The process may be used in the molding of partial shoe bottoms as well, such a sole or a heal, and the term “shoe bottom” includes a partial shoe bottom.

1. A process for producing a mold in which a shoe bottom may be molded; said process comprising:
providing a model having contoured surfaces corresponding to surfaces desired for the shoe bottom;
applying a metallic coating to the contoured surfaces of the model;
forming a rigid backing over the metallic coating, thereby providing a drag having a mold cavity occupied by the model; and
removing the model from the mold cavity.

2. The process according to claim 1 wherein the coating extends laterally beyond the model.

3. The process according to claim 1 and further comprising:
providing a cope having a positioning surface and a parting surface surrounding the positioning surface; and wherein the model is placed against the positioning surface of the cope before the metallic coating is applied to it.

4. The process according to claim 1 wherein the metallic coating is also applied to the parting surface of the cope, and the backing is also formed over the metallic coating that is over the parting surface of the cope, whereby the metallic coating that is over the parting surface of the cope becomes a parting surface for the drag.

5. The process according to claim 4 wherein forming a backing over the coated contoured surfaces of the model includes:
installing a form along the parting surface of the cope such that it surrounds the model on the cope to provide a form cavity; and
introducing a fluent backing material into the form cavity and allowing it to solidify and form the backing.

6. The process according to claim 5 wherein the coating, the solidified backing, and the form comprise the drag.

7. The process according to claim 5 wherein the backing is a thermosetting polymer.

8. The process according to claim 5 wherein the metallic coating is applied to the model and to the parting surface of the cope by flame spraying.

9. A process for molding a shoe bottom, said process comprising:
providing a mold constructed in accordance with claim 4;
bringing the drag and cope together at their parting surfaces to enclose the mold cavity;
thereafter introducing a fluent thermoplastic polymer into the enclosed mold cavity; and
allowing the fluent thermoplastic material to solidify in the mold cavity into a shoe bottom.

10. The process according to claim 9 and further comprising:
separating the cope and drag; and
removing the shoe bottom from the mold cavity.

11. A drag for a mold for producing a shoe bottom; said drag comprising:
a form;
a backing located within the form and containing a mold cavity that opens out of the backing; and
a metallic coating adhered to the backing and lining the mold cavity and also extending away from the cavity to provide a parting surface over the backing.

12. A mold for producing a shoe bottom, said mold comprising:
the drag of claim 1 1, and
a cope having a parting surface that is against the parting surface of the drag and closes the mold cavity.

13. A mold according to claim 12 wherein the parting surface of the cope conforms to the parting surface of the drag.
